(19) United States
(12) Patent Application Publication
(10) Pub. No.: US 2025/0303383 A1
(43) Pub. Date: Oct. 2, 2025

(54) HYDROGEN GENERATION APPARATUS

(71) Applicant: CANON KABUSHIKI KAISHA, Tokyo (JP)

(72) Inventors: SHOKO FUJIWARA, Ibaraki (JP); KEIJI KARUBE, Ibaraki (JP); AKIKO TOMINAGA, Kanagawa (JP); TSUYOSHI KUROKI, Kanagawa (JP); SHUNSUKE TSUDA, Tokyo (JP); KENJI UTSUNOMIYA, Tokyo (JP)

(21) Appl. No.: 19/240,639

(22) Filed: Jun. 17, 2025

Related U.S. Application Data
(63) Continuation of application No. PCT/JP2023/044542, filed on Dec. 13, 2023.

(30) Foreign Application Priority Data
Dec. 20, 2022 (JP) 2022-203051

(51) Int. Cl. B01J 8/10; B01J 8/00; B01J 8/08; C01B 3/06

(52) U.S. Cl. CPC B01J 8/10; B01J 8/002; B01J 8/082; B01J 8/085; C01B 3/065; B01J 2208/00752

(57) ABSTRACT

A hydrogen generation apparatus applies a solid hydrogen carrier on a surface of a conveyance member by an application apparatus, and ejects a solution containing water onto the hydrogen carrier applied on the surface by an ejection apparatus. Then, hydrogen generated by a reaction between the hydrogen carrier and the solution on the surface is collected by a hydrogen collection apparatus. A byproduct generated by the reaction between the hydrogen carrier and the solution on the surface is collected by a byproduct collection apparatus. A hydrogen carrier regulated amount maintaining portion adjusts the replenishment amount of the hydrogen carrier from a replenishment container to a storage portion of the application apparatus to maintain the hydrogen carrier in the storage portion within a predetermined range.

### CROSS-REFERENCE TO RELATED APPLICATIONS

This application is a Continuation of International Patent Application No. PCT/JP2023/044542, filed Dec. 13, 2023, which claims the benefit of Japanese Patent Application No. 2022-203051, filed Dec. 20, 2022, both of which are hereby incorporated by reference herein in their entirety.

### BACKGROUND

### Field of the Technology

The present disclosure relates to a hydrogen generation apparatus that generates hydrogen by using, as a raw material, a hydrogen carrier having a nature to generate hydrogen when a water-containing solution is poured thereon.

### Description of the Related Art

As a hydrogen generation apparatus, an apparatus that supplies water and a solvent to sodium borohydride and generates hydrogen by hydrolysis of the sodium borohydride is proposed (for example, Patent Literature 1).

### CITATION LIST

### Patent Literature

Patent Literature 1: Japanese Patent Application Laid-Open No. 2017-114708

### SUMMARY

Here, as a configuration of generating hydrogen by supplying a water-containing solution to a hydrogen carrier such as sodium borohydride, a configuration in which the hydrogen carrier is applied on a conveyance member and the solution is supplied to this hydrogen carrier can be considered. In the case of this configuration, if the thickness of the hydrogen carrier on the surface of the conveyance member is uneven, the progress of reaction caused by the supply of the solution also becomes uneven.

The present disclosure provides a hydrogen generation apparatus that easily promotes a reaction between a hydrogen carrier and a water-containing solution.

According to a first aspect of the present disclosure, a hydrogen generation apparatus includes a conveyance member capable of conveying a solid hydrogen carrier; a replenishment container storing the hydrogen carrier for replenishment, an application apparatus that includes a storage portion configured to store the hydrogen carrier supplied from the replenishment container and that is configured to apply the hydrogen carrier on the conveyance member from the storage portion, an ejection apparatus configured to eject a solution containing water onto the hydrogen carrier applied on the conveyance member, a hydrogen collection apparatus configured to collect hydrogen generated by a reaction between the hydrogen carrier and the solution on the conveyance member, a byproduct collection apparatus configured to collect a byproduct generated by the reaction between the hydrogen carrier and the solution on the conveyance member, and a hydrogen carrier regulated amount maintaining portion configured to adjust a replenishment amount of the hydrogen carrier from the replenishment container to the storage portion to maintain the hydrogen carrier in the storage portion within a predetermined range.

According to a second aspect of the present disclosure, a hydrogen generation apparatus includes a conveyance member capable of conveying a solid hydrogen carrier, a replenishment container storing the hydrogen carrier for replenishment, an application apparatus including an accumulating portion configured to temporarily accumulate the hydrogen carrier supplied from the replenishment container, a storage portion configured to store the hydrogen carrier, a supply portion configured to supply the hydrogen carrier from the accumulating portion to the storage portion, and configured to apply the hydrogen carrier on the conveyance member from the storage portion, an ejection apparatus configured to eject a solution containing water onto the hydrogen carrier applied on the conveyance member, a hydrogen collection apparatus configured to collect hydrogen generated by a reaction between the hydrogen carrier and the solution on the conveyance member, a byproduct collection apparatus configured to collect a byproduct generated by the reaction between the hydrogen carrier and the solution on the conveyance member, and a hydrogen carrier regulated amount maintaining portion configured to adjust a supply amount of the hydrogen carrier from the accumulating portion to the storage portion to maintain the hydrogen carrier in the storage portion within a predetermined range.

Features of the present disclosure will become apparent from the following description of embodiments with reference to the attached drawings.

### BRIEF DESCRIPTION OF THE DRAWINGS

FIG. 1 is a schematic configurational section view of a hydrogen generation apparatus according to a first embodiment.

FIG. 2 is a control block diagram of the hydrogen generation apparatus according to the first embodiment.

FIG. 3 is a schematic configurational section view illustrating an enlarged view of the vicinity of a powder application apparatus in a state in which a shutter of a hydrogen carrier storage case is closed in the hydrogen generation apparatus according to the first embodiment.

FIG. 4 is a schematic configurational section view illustrating an enlarged view of the vicinity of a powder application apparatus in a state in which the shutter of the hydrogen carrier storage case is open in the hydrogen generation apparatus according to the first embodiment.

FIG. 5 is a schematic configurational section view illustrating an enlarged view of the vicinity of a powder application apparatus in a hydrogen generation apparatus according to a second embodiment.

### DESCRIPTION OF THE EMBODIMENTS

### First Embodiment

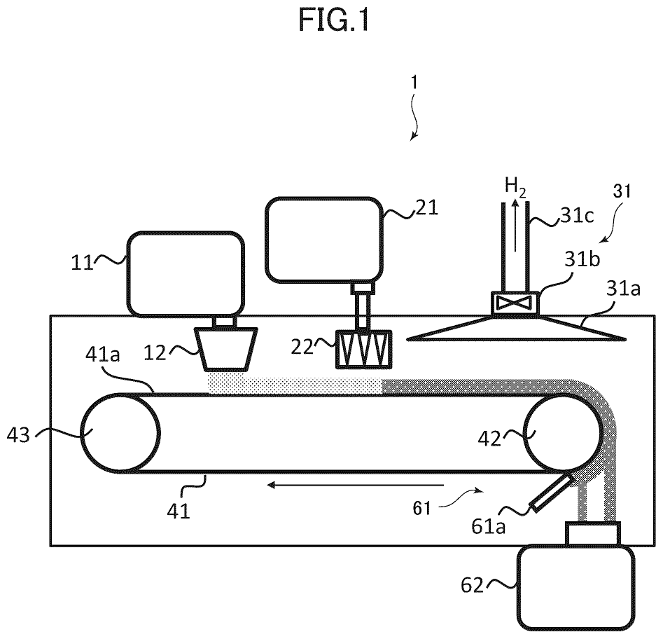

A first embodiment will be described with reference to FIGS. 1 to 4. First, hydrogen is attracting attention as an energy source to replace fossil fuel. This is because, unlike fossil fuel, when being combusted, hydrogen does not generate, for example, carbon dioxide that is a kind of a greenhouse gas that causes global warming. One example of a system that uses hydrogen as an energy source and that is put into practical use is a fuel cell vehicle. A fuel cell vehicle is an automobile that generates power by using hydrogen as a raw material and moves by driving an electric motor by the generated power. Most of fuel cell vehicles store hydrogen serving as an energy source in a hydrogen tank, and generates power by charging the hydrogen discharged from the hydrogen tank into a fuel cell. In the hydrogen tank, hydrogen is stored in a compressed state at a high pressure such as 70 MPa (700 times as high as atmospheric pressure).

Hydrogen serving as an energy source has a problem that the energy density thereof is low. The volume energy density of hydrogen is about 1/3000 of that of gasoline, and energy of only about ⅕ of that of gasoline of the same volume can be obtained even if the hydrogen tank of 70 MPa is used. Therefore, typically, a fuel cell vehicle including a hydrogen tank is required to be charged with energy more frequently than an automobile using gasoline.

Therefore, as a material (that is, a hydrogen carrier) that can carry hydrogen at a higher energy density than a hydrogen tank, various materials are considered. For example, ammonia, methylcyclohexane, and the like are known as hydrogen carriers, and transporting a hydrogen carrier instead of hydrogen itself and taking out hydrogen from the hydrogen carrier at use are performed.

Among hydrogen carrier materials like these, metal hydrides such as sodium borohydride from which hydrogen can be easily taken out by pouring water thereon are widely known. As a method of obtaining hydrogen by hydrolysis of sodium borohydride, a method of dissolving sodium borohydride in water and using it as an aqueous solution is known. However, in the case of this method, there is a problem that more water than an amount required in the theory represented by the reaction formula is required, and thus the substantial volume energy density is reduced.

Therefore, in the present embodiment, hydrogen is generated by pouring a water-containing liquid on a solid hydrogen carrier by a hydrogen generation apparatus configured as described below. In addition, a byproduct generated by the reaction between the hydrogen carrier and the liquid is collected. The byproduct can be restored into the hydrogen carrier. [Hydrogen Generation Apparatus]

A schematic configuration of hydrogen generation apparatus 1 will be described by using FIG. 1. The hydrogen generation apparatus 1 of the present embodiment is an apparatus that places a hydrogen carrier that is solid (powder in the present embodiment) on the conveyance belt 41, ejects a water-containing liquid thereonto, reacts the hydrogen carrier with the water-containing liquid on the conveyance belt 41, and thus generates hydrogen. The hydrogen generation apparatus 1 mainly includes the conveyance belt 41, a powder application apparatus 12 serving as an application apparatus, a liquid ejection apparatus 22 serving as an ejection apparatus, a hydrogen collection apparatus 31, and a byproduct collection apparatus 61.

The conveyance belt 41 rotates in an arrow direction of FIG. 1. The powder application apparatus 12 receives supply of hydrogen carrier from a hydrogen carrier storage case 11 storing a hydrogen carrier that is powder, and applies the hydrogen carrier on a surface 41a of the conveyance belt 41. The liquid ejection apparatus 22 is disposed downstream of the powder application apparatus 12 in the rotational direction of the conveyance belt 41, receives supply of the liquid from a liquid storage case 21 storing the water-containing liquid, and ejects the liquid onto the hydrogen carrier applied on the surface 41a of the conveyance belt 41.

The hydrogen collection apparatus 31 is disposed downstream of the liquid ejection apparatus 22 in the rotational direction of the conveyance belt 41, and collects hydrogen generated by the reaction between the hydrogen carrier and the liquid on the surface 41a of the conveyance belt 41. The byproduct collection apparatus 61 collects the byproduct generated by the reaction between the hydrogen carrier and the liquid on the surface 41a of the conveyance belt 41. The byproduct mentioned herein refers to a product other than hydrogen generated by the reaction between the hydrogen carrier and the liquid. In addition, the hydrogen generation apparatus 1 of the present embodiment further includes a hydrogen carrier regulated amount maintaining portion 13 that maintains the hydrogen carrier in the powder application apparatus 12 within a predetermined range.

The hydrogen generation apparatus 1 can perform, on the conveyance belt 41, a series of steps such as generating hydrogen by the reaction between the hydrogen carrier and the water-containing liquid, and collecting the byproduct after the reaction. Therefore, an advantage that hydrogen can be generated continuously, stably, and in a long term is realized in a compact apparatus configuration.

The operation of the hydrogen generation apparatus 1 is as follows. First, the conveyance belt 41 starts operating, and when the conveyance speed of the conveyance belt 41 has become stable at a predetermined speed and the surface temperature of the conveyance belt 41 has reached a set temperature, the powder application apparatus 12 starts operating, and applies the hydrogen carrier on the conveyance belt 41. The liquid is ejected from the liquid ejection apparatus 22 at a timing when the hydrogen carrier comes under the liquid ejection apparatus 22, thus the reaction between the hydrogen carrier and the liquid is started, and the generated hydrogen is collected by the hydrogen collection apparatus 31. Then, the byproduct generated after the reaction between the hydrogen carrier and the water-containing liquid is conveyed to the byproduct collection apparatus 61, and the byproduct is collected and sent to a byproduct collection case 62 by the byproduct collection apparatus 61. Next, each constituent element will be described in detail.

### [Hydrogen Carrier]

The “hydrogen carrier” mentioned in the present embodiment is not particularly limited as long as the hydrogen carrier is a solid hydrogen carrier that generates hydrogen when a water-containing liquid is poured thereon. For example, solid metal hydrides such as sodium borohydride, potassium borohydride, lithium borohydride, zinc borohydride, aluminum lithium hydride, aluminum sodium hydride, aluminum magnesium hydride, aluminum calcium hydride, magnesium hydride, lithium hydride, sodium hydride, and calcium hydride, and metal powder such as aluminum, zinc, calcium, and magnesium can be used solely or in combination. In addition, an additive such as a reaction accelerator or a desiccant may be contained.

In addition, although the hydrogen carrier of the present embodiment is preferably a solid such as powder or granule, but solids such as sheets, pellets, and pastes are also usable. As the powder, one having a particle diameter of about 10 μm or more and 10 mm or less, and one having a particle diameter of 10 μm or more and 3 mm or less, and further one having a particle diameter of 10 μm or more and 100 μm or less are more preferable. In addition, in the case of use in the form of a sheet or a pellet, it is preferable to perform surface roughening, pore-forming treatment, or the like to increase the surface area and increase the contact area with the water-containing liquid from the viewpoint of enhancing the reactivity with the water-containing liquid.

In the present embodiment, a powder of sodium borohydride having an average particle diameter of 50 μm is used as the solid hydrogen carrier. To be noted, the average particle diameter of the solid hydrogen carrier is not limited to this. The sodium borohydride powder reacts with water to generate hydrogen. The reacted sodium borohydride turns into a powder of sodium metaborate that is a byproduct. This reaction is expressed as follows by a chemical formula.

NaBH₄ (sodium borohydride)+2H₂O (water)→NaBO₂ (sodium metaborate)+4H₂ (hydrogen) (1)

This reaction (chemical formula (1)) is known to be promoted by a Raney catalyst formed from metal such as nickel, cobalt, or copper, and an acidic solution such as citric acid or acetic acid.

### [Water-Containing Liquid]

The “water-containing liquid” mentioned in the present embodiment is not particularly limited as long as the liquid reacts with the hydrogen carrier and generates hydrogen when poured. That is, the water-containing liquid may be a simple of water. In addition, two or more kinds of water-containing liquids may be prepared. By preparing two or more kinds of water-containing liquids, the generation speed of hydrogen can be adjusted.

The water-containing liquid can include a water-soluble organic solvent. Examples thereof can include alcohols, polyalkylene glycols, glycol ethers, nitrogen-containing compounds, and sulfur-containing compounds. Two kinds or more selected from these can be also used in mixture. By containing a water-soluble organic solvent, adjustment of the surface tension, adjustment of the boiling point and melting point of the water-containing liquid can be performed to optimize the reaction with the hydrogen carrier.

A surfactant can be added to the water-containing liquid. By using the surfactant, the surface tension of the water-containing liquid can be reduced, the contact area with the hydrogen carrier can be increased, and thus efficient reaction can be performed.

The water-containing liquid can contain a water-soluble acidic substance. The acidic substance functions as a positive catalyst in the reaction between the water-containing liquid and the hydrogen carrier. By adjusting the amount of the liquid containing the acidic substance, the generation speed of hydrogen can be adjusted. Particularly, by setting the pH obtained by the water-containing liquid and the hydrogen carrier to be lower than 9.0, the hydrogen generation speed can be increased. Examples thereof include various acids such as chloric acid, sulfuric acid, nitric acid, boric acid, and organic acids, but are not limited to these.

The water-containing liquid can include a water-soluble basic substance. The basic substance functions as a negative catalyst in the reaction between the water-containing liquid and the hydrogen carrier. By adjusting the amount of the liquid containing the basic substance, the generation speed of hydrogen can be adjusted. Particularly, by setting the pH obtained by the water-containing liquid and the hydrogen carrier to be equal to or higher than 9.0, the hydrogen generation speed can be reduced. Examples thereof include bases such as sodium hydrate, potassium hydrate, and ammonia water, but are not limited to these.

The water-containing liquid can include a buffer liquid. The buffer liquid functions to suppress pH fluctuation in the reaction between the water-containing liquid and the hydrogen carrier. By adjusting the amount of the liquid containing the buffer liquid, the generation speed of hydrogen can be adjusted. Examples thereof include various buffer liquids such as a phosphoric acid buffer liquid, a glycine buffer liquid, a Good's buffer liquid, a Tris buffer liquid, and an ammonia buffer liquid, but are not limited to these.

The water-containing liquid may contain various additives such as a defoaming agent, a pH adjuster, a viscosity adjuster, a rust inhibitor, an antiseptic agent, an antifungal agent, an antioxidant, and an anti-reduction agent in addition to the components described above if necessary.

### [Conveyance Belt]

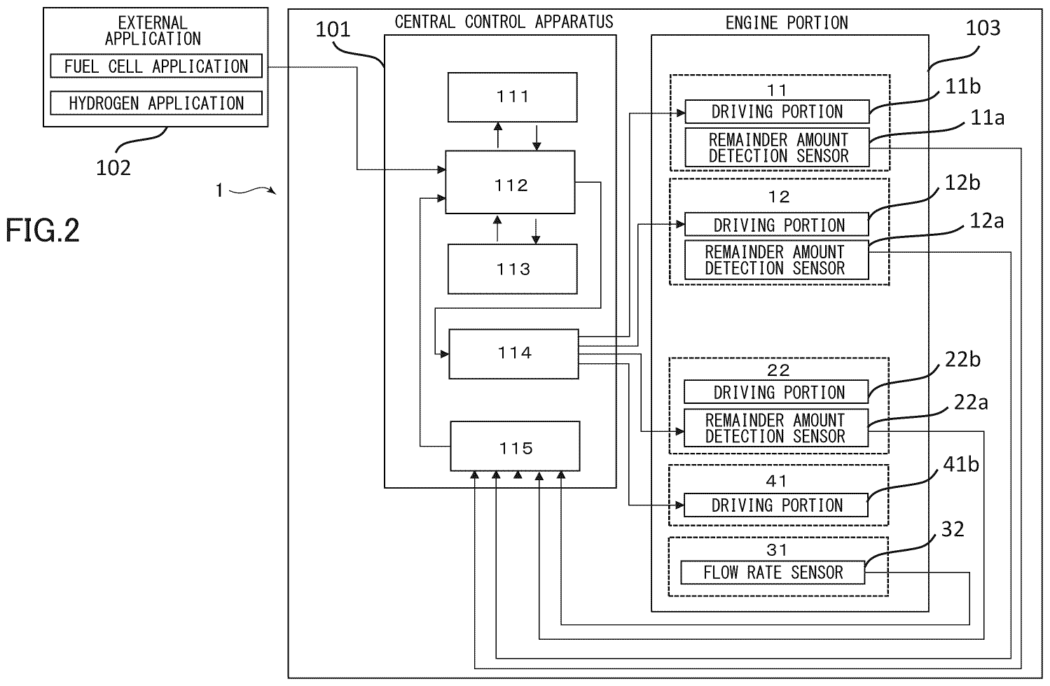

The conveyance belt 41 serving as a conveyance member is an endless belt, and is capable of conveying the solid hydrogen carrier. The conveyance belt 41 is stretched by the driving roller 42 and the driven roller 43. The driving roller 42 is fixed, the driven roller 43 is subjected to a force pushing out the driven roller 43 to the front surface side of the conveyance belt by the urging force of an unillustrated urging spring, and a certain tension is applied to the conveyance belt 41 due to this force. In addition, the driving roller 42 is coupled to a driving portion 41b (see FIG. 2) such as a motor, and thus the conveyance belt 41 circulates (i.e. rotates) in a clockwise direction (arrow direction) of FIG. 1 as a result of the driving roller 42 being rotationally driven by the driving portion 41b. Although the conveyance belt 41 is supported by two rollers in the present embodiment, there is no problem if, for example, the conveyance belt 41 is supported by a plurality of rollers such as three rollers.

In either case, the conveyance belt 41 is provided such that a stretched surface stretched by two rollers (the driving roller 42 and the driven roller 43 in the present embodiment), that is, the surface 41a described above is oriented in approximately the horizontal direction. In addition, the surface 41a is a surface facing up, and the powder application apparatus 12, the liquid ejection apparatus 22, and the hydrogen collection apparatus 31 disposed above the conveyance belt 41 oppose the surface 41a.

The conveyance belt 41 configured in this manner includes a mechanism that functions to convey the hydrogen carrier applied on the conveyance belt 41 by the powder application apparatus 12 toward the downstream side in the rotational direction in the order of the liquid ejection apparatus 22 and the hydrogen collection apparatus 31. After this, the byproduct after the reaction is conveyed further downstream to the byproduct collection apparatus 61.

The conveyance belt 41 is preferably imparted with electrical conductivity from the viewpoint of not causing static electricity, and may be formed from metal or resin. In the case of metal, aluminum, iron, copper, Ni, stainless steel (SUS), and the like can be used. In addition, in the case of resin, a resin having a high glass transition temperature is preferable from the viewpoint of heat resistance, and for example, engineering plastics having high heat resistance and high durability such as polyimide, polyamideimide, and polyether ether ketone are preferable. In addition, in the case of resin not having electrical conductivity, it is preferable that the resin contains an antistatic agent such as carbon black to have electrical conductivity imparted. In addition, it is preferable that the thickness of the conveyance belt 41 is about 30 μm or more and 200 μm or less from the viewpoint of thermal conductivity. In the present embodiment, an endless belt formed from resin imparted with electrical conductivity that is polyimide containing carbon is used as the conveyance belt 41.

The conveyance speed (rotational speed) of the conveyance belt 41 is a predetermined speed set for each kind of the hydrogen carrier and the water-containing liquid that are used. In addition, it is preferable that the conveyance speed is adjustable as appropriate in accordance with the required hydrogen amount. As a result of this, in the case where, for example, the amount of hydrogen collected by the hydrogen collection apparatus 31 has not reached a planned amount, the hydrogen generation amount can be adjusted by, for example, appropriately adjusting the conveyance speed in accordance with the hydrogen amount measured by a flow rate sensor 32 (see FIG. 2) or the like that measures the flow rate of the hydrogen collected by the hydrogen collection apparatus 31. To be noted, the conveyance member that conveys the hydrogen carrier in this manner is not limited to a conveyance belt, and may be, for example, a different element such as a rotatable drum or a movable stage.

### [Powder Application Apparatus]

The powder application apparatus 12 is an apparatus that receives supply of the hydrogen carrier from the hydrogen carrier storage case 11 and applies the hydrogen carrier on the conveyance belt 41. There is no problem if the thickness of the hydrogen carrier applied on the conveyance belt 41 is about 50 μm or more and 3 mm or less, but it is preferable that the thickness is set to 50 μm or more and 500 μm or less to improve the reactivity with the water-containing liquid.

In addition, the hydrogen carrier storage case 11 serving as a hydrogen carrier replenishment container stores hydrogen carrier (hydrogen carrier for replenishment) for replenishment of the storage portion of the powder application apparatus 12. The hydrogen carrier storage case 11 is attachable to and detachable from the powder application apparatus 12. That is, the hydrogen carrier storage case 11 is replaceable.

The powder application apparatus 12 applies the hydrogen carrier on the conveyance belt 41 by only the gravity or by the gravity and an external force from rotation of a paddle, a roller, a brush roller, a screw fin, or the like therein. The supply of the hydrogen generating substance to the conveyance belt 41 becomes stagnant when the powder application apparatus 12 becomes empty, and therefore it is preferable that a sensor that detects the remainder amount of the hydrogen carrier is provided in the powder application apparatus 12. As the sensor, a piezoelectric sensor, an optical sensor, an electrostatic capacitance sensor, an ultrasonic wave sensor, and the like can be considered. The detailed configuration of the powder application apparatus 12 will be described later.

### [Liquid Ejection Apparatus]

The liquid ejection apparatus 22 is a liquid application apparatus that receives supply of the water-containing liquid from the liquid storage case 21 storing the water-containing liquid and applies the water-containing liquid on the hydrogen carrier on the conveyance belt 41. The liquid ejection apparatus 22 can adjust the amount of the water-containing liquid with respect to the amount of the hydrogen carrier. The liquid ejection apparatus 22 may eject the liquid onto the conveyance belt 41 in a contactless manner, or may eject the liquid in contact.

The liquid ejection apparatus 22 of a contactless type has no particular problem as long as the liquid ejection apparatus 22 is one that can apply the water-containing liquid on the hydrogen carrier such as a spray system, a shower system, or a dispenser system. Any of these systems can adjust the ejection amount of the liquid. In addition, as the liquid ejection apparatus 22 of a contact type, a gravure offset roller, a bar coater, a die coater, a blade coater, a knife coater, and the like can be mentioned. Any of these systems can adjust the ejection amount of the liquid.

In addition, the liquid storage case 21 serving as a liquid replenishment container stores the water-containing liquid to be supplied to the liquid ejection apparatus 22. The liquid storage case 21 is attachable to and detachable from the liquid ejection apparatus 22. That is, the liquid storage case 21 is replaceable.

### [Hydrogen Collection Apparatus]

The hydrogen collection apparatus 31 is provided for collecting the hydrogen generated by the reaction between the hydrogen carrier and the water-containing liquid. As illustrated in FIG. 1, it may be a canopy structure in a sense of an exhaustion apparatus, or may be one in which an upper outer wall of the hydrogen generation apparatus 1 has a slope shape and a discharge port is provided at the highest position. There is no particular problem as long as the structure collects the hydrogen generated inside the hydrogen generation apparatus 1. The hydrogen collection apparatus 31 of the present embodiment is disposed above the conveyance belt 41, and includes a collection portion 31a that collects the hydrogen generated on the conveyance belt 41, and a suction fan 31b that sucks the hydrogen collected by the collection portion 31a. The hydrogen sucked by the suction fan 31b is supplied to a supply destination such as a fuel cell through a pipe 31c.

In the fuel cell serving as one of supply destinations of hydrogen, dry hydrogen is desired. However, not only hydrogen but also a water vapor or a vapor of an alkaline substance generated by the reaction can mix into the collected gas. Therefore, it is preferable that a mechanism that removes substances other than a hydrogen gas, such as a filter containing water, a filter containing silica gel, or a steam trap incorporating a cooling apparatus, is provided in the flow path for hydrogen such as the pipe 31c.

### [Byproduct Collection Apparatus]

The byproduct collection apparatus 61 functions to remove the byproduct on the conveyance belt 41 from the conveyance belt 41 and send the byproduct to the byproduct collection case 62. The byproduct is, for example, sodium metaborate in the case where the hydrogen carrier is sodium borohydride. The byproduct collection apparatus 61 includes a collection blade 61a that comes into contact with the conveyance belt 41, and a blade holding member (illustration omitted) that holds the collection blade 61a.

The collection blade 61a preferably abuts the outer peripheral surface of the conveyance belt 41 stretched by a roller stretching the conveyance belt 41, which is the driving roller 42 in the present embodiment. In addition, the collection blade 61a preferably abuts a surface other than the surface 41a, such as the lower surface in the vertical direction or a side surface in the horizontal direction of the conveyance belt 41. In addition, the byproduct collection case 62 is preferably disposed below the collection blade 61a in the vertical direction. As a result of this, the byproduct collected by the collection blade 61a can be dropped by the gravity and collected by the byproduct collection case 62.

The material of the collection blade 61a is not particularly limited, and examples thereof include a rubber blade formed from rubber and used for cleaning of an intermediate transfer belt in a copier or the like. This is formed from rubber such as silicone rubber or urethane rubber, is molded into a plate shape, is attached such that the corner portion thereof is in contact in a counter direction with respect to the movement direction of the conveyance belt 41, and thus removes the byproduct on the conveyance belt 41. In addition, there is no problem in using one formed from metal or glass in a spatula shape, which is a so-called scraper, as the collection blade 61a.

The blade holding member has a function to support the collection blade 61a and apply a certain pressure to the collection blade 61a by using the warpage of the blade holding member. Although the material thereof is not particularly limited, metal is preferred because pressure is to be applied.

In addition, the byproduct collection case 62 serving as a collection container is a case for collecting the byproduct collected from the conveyance belt 41 by the collection blade 61a. The byproduct collection case 62 is attachable to and detachable from the byproduct collection apparatus 61. That is, the byproduct collection case 62 is replaceable.

### [Central Control Apparatus]

FIG. 2 is a block diagram illustrating a system of the hydrogen generation apparatus 1 of the present embodiment. A central control apparatus 101 includes a controller 112, a random access memory (RAM) 111, a storage 113 that stores a program, a communication interface, a signal transmitting portion 114, and a signal receiving portion 115. The controller 112 is constituted by a central processing unit (CPU) or a CPU and a read-only memory (ROM), and issues a control command to the whole hydrogen generation apparatus 1 by executing the program stored in the storage 113.

The RAM 111 is a main memory for work by the controller 112. The storage 113 is a storage region for storing a control program and the like, and the controller 112 performs processing by reading a control program, time-series data that is temporarily stored, log information, and the like from the RAM 111 and the storage 113.

Information from an external application 102 such as hydrogen application of the fuel cell to which the hydrogen generation apparatus 1 supplies or fuel cell application of a fuel cell vehicle (FCV) or the like that uses a fuel cell is input to the controller 112. In addition, the controller 112 receives information of an engine portion 103 of the hydrogen generation apparatus 1 through the signal receiving portion 115. As the information of the engine portion 103, a hydrogen amount detected by the flow rate sensor 32 provided in the hydrogen collection apparatus 31, information of remainder amount detection sensors 11a, 12a, and 22a provided in the hydrogen carrier storage case 11, the powder application apparatus 12, and the liquid ejection apparatus 22, and the like can be mentioned.

The remainder amount detection sensor 11a is a sensor that is provided in the hydrogen carrier storage case 11 and detects the remainder amount of the hydrogen carrier in the hydrogen carrier storage case 11. The remainder amount detection sensor 12a is a sensor that is provided in the powder application apparatus 12 and detects the remainder amount of the hydrogen carrier in the powder application apparatus 12. The remainder amount detection sensor 22a is a sensor that is provided in the liquid ejection apparatus 22, and detects the remainder amount of the water-containing liquid in the liquid ejection apparatus 22.

Further, the controller 112 transmits, as a signal generated in accordance with a control information set in advance, a replenishment signal to the hydrogen carrier storage case 11, a driving signal to the powder application apparatus 12 and the liquid ejection apparatus 22, a driving signal to the conveyance belt 41, and the like, via the signal transmitting portion 114.

The hydrogen carrier storage case 11 includes a driving portion 11b for replenishing the powder application apparatus 12 with the hydrogen carrier. The powder application apparatus 12 includes a driving portion 12b for applying the hydrogen carrier on the conveyance belt 41. The liquid ejection apparatus 22 includes a driving portion 22b for ejecting the liquid onto the hydrogen carrier on the conveyance belt 41. In addition, the conveyance belt 41 is driven by the driving portion 41b as described above. The controller 112 controls the drive of the driving portions 11b, 12b, 22b, and 41b.

Specifically, the driving portion 11b of the hydrogen carrier storage case 11 is, for example, a motor or a solenoid that drives a shutter provided at a connecting portion between the hydrogen carrier storage case 11 and the powder application apparatus 12. The controller 112 performs and stops the replenishment operation of the hydrogen carrier from the hydrogen carrier storage case 11 to the powder application apparatus 12 by, for example, driving the driving portion 11b to open and close the shutter.

The driving portion 12b of the powder application apparatus 12 is, for example, a motor that drives a roller for applying the hydrogen carrier on the conveyance belt 41. The controller 112 drives the driving portion 12b to control the drive of the roller, and thus performs and stops the application operation of the hydrogen carrier from the powder application apparatus 12 to the surface 41a of the conveyance belt 41.

The driving portion 22b of the liquid ejection apparatus 22 is, for example, provided to eject the liquid onto the conveyance belt 41, and the driving configuration thereof differs depending on the system thereof. The controller 112 controls the drive of the driving portion 22b, and thus performs and stops the liquid ejection operation from the liquid ejection apparatus 22 to the surface 41a of the conveyance belt 41.

The driving portion 41b of the conveyance belt 41 is, for example, a motor as described above. The controller 112 controls the drive of the driving portion 41b, and thus drives and stops the conveyance belt 41, and further controls the driving speed thereof. [Hydrogen Carrier Regulated Amount Maintaining Portion]

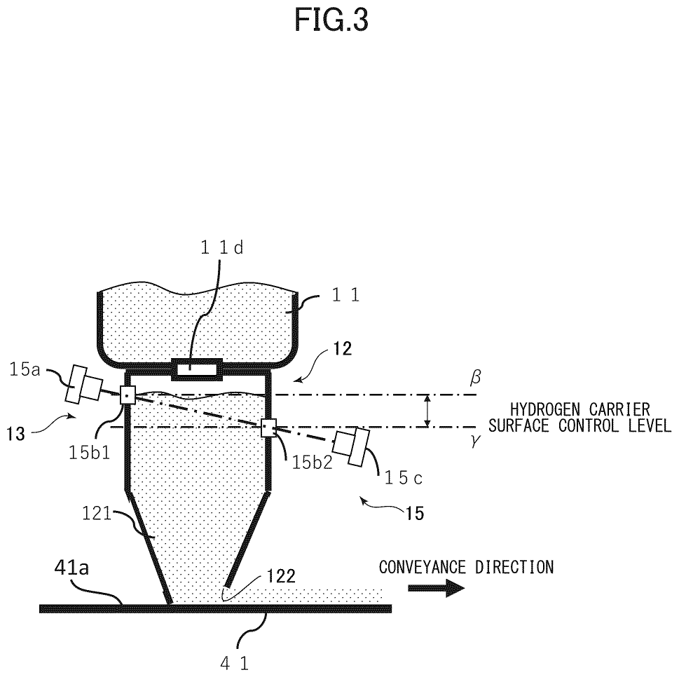

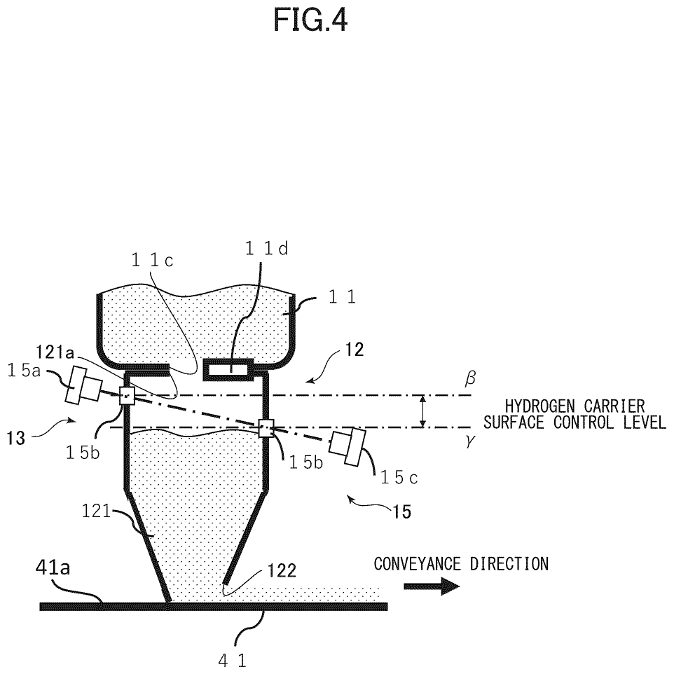

Next, the hydrogen carrier regulated amount maintaining portion 13 that maintains the hydrogen carrier in the powder application apparatus 12 within a predetermined range will be described by using FIGS. 3 and 4. In the case where the hydrogen carrier applied on the conveyance belt 41 by the powder application apparatus 12 as described above is uneven in terms of thickness, the reaction speed with the water-containing liquid on the belt becomes uneven, and there is a possibility that the hydrogen carrier is conveyed downstream although the hydrolysis reaction has not progressed sufficiently. Then, there is a possibility that the unreacted hydrogen carrier is mixed into the byproduct collection apparatus 61. As a demerit of the reaction not progressing sufficiently, the amount of hydrogen that can be collected decreasing to lower the energy efficiency, the unreacted hydrogen carrier mixing into the byproduct collection apparatus 61 to fill the byproduct collection apparatus 61 with hydrogen, and the like can be mentioned.

Here, if the change in the amount of the hydrogen carrier in the powder application apparatus 12 is large, the change in the gravity force and pressure on the hydrogen carrier near the application port from the powder application apparatus 12 to the conveyance belt 41 becomes also large. As a result of this, there is a possibility that the application amount of the hydrogen carrier from the powder application apparatus 12 to the conveyance belt 41 becomes uneven. Therefore, in the present embodiment, the replenishment amount of the hydrogen carrier from the hydrogen carrier storage case 11 to the powder application apparatus 12 is adjusted to maintain the hydrogen carrier in the powder application apparatus 12 within a predetermined range.

First, a detailed configuration of the powder application apparatus 12 and the hydrogen carrier storage case 11 will be described. The powder application apparatus 12 includes a storage portion 121 that stores the hydrogen carrier supplied from the hydrogen carrier storage case 11 serving as a replenishment container, and applies the hydrogen carrier on the conveyance belt 41 (on the conveyance member) from the storage portion 121. An opening portion 122 is formed at a lower end portion of the storage portion 121. The hydrogen carrier in the storage portion can be supplied onto the surface 41a of the conveyance belt 41 through the opening portion 122 by gravity.

The hydrogen carrier storage case 11 is disposed above the storage portion 121 of the powder application apparatus 12, and includes an opening portion 11c capable of supplying the hydrogen carrier into the storage portion by gravity, and a shutter 11d capable of opening and closing the opening portion 11c. The shutter 11d serving as a replenishment portion is provided for replenishing the storage portion 121 with the hydrogen carrier from the hydrogen carrier storage case 11. The shutter 11d is driven by an unillustrated driving portion such as a motor or a solenoid, and opens and closes the opening portion 11c in response to the driving portion being controlled by an instruction from the controller 112 (see FIG. 2).

FIG. 3 illustrates a state in which the shutter 11d is closed, and FIG. 4 illustrates a state in which the shutter 11d is open. As illustrated in FIG. 4, as a result of the shutter 11d opening, the hydrogen carrier in the hydrogen carrier storage case 11 is supplied into the storage portion 121 by gravity through the opening portion 11c and the supply port 121a formed at an upper end portion of the storage portion 121 of the powder application apparatus 12.

The hydrogen carrier regulated amount maintaining portion 13 includes a hydrogen carrier amount detection portion 15 capable of detecting information about the amount of the hydrogen carrier in the storage portion 121 of the powder application apparatus 12, and the controller 112 that controls the shutter 11d on the basis of a signal of the hydrogen carrier amount detection portion 15. The powder application apparatus 12 is disposed above the conveyance belt 41 as described above, and is capable of supplying the hydrogen carrier onto the conveyance belt 41 by gravity. Therefore, the hydrogen carrier amount detection portion 15 of the present embodiment is configured to detect information about the height of the upper surface of the hydrogen carrier in the storage portion 121.

Specifically, the hydrogen carrier amount detection portion 15 is an optical detection sensor, and includes a light emitting portion 15a constituted by a light emitting element, window portions 15b1 and 15b2 that transmit light, and a light receiving portion 15c constituted by a light receiving element. The window portions 15b1 and 15b2 are provided in a side wall of the storage portion 121 respectively at positions opposing the light emitting portion 15a and light receiving portion 15b.

In the present embodiment, the height positions of the light emitting portion 15a and the light receiving portion 15c are different as illustrated in FIG. 3. Therefore, the light emitted from the light emitting portion 15a travels obliquely with respect to the horizontal direction to enter the inside of the storage portion 121 through the window portion 15b1, and further travels through the window portion 15b2 to be received by the light receiving portion 15c. Further, the controller 112 measures the proportion of the light transmission time from the light emitting portion 15a to the light receiving portion 15c, and thus obtains the height information of the upper surface (surface) of the hydrogen carrier in the storage portion 121.

Here, the height position of the window portion 15b1 through which the light from the light emitting portion 15a enters the inside of the storage portion 121 will be denoted by β, and the height position of the window portion 15b2 that the light passes from the inside of the storage portion 121 toward the light receiving portion 15c will be denoted by γ. The controller 112 controls the replenishment from the hydrogen carrier storage case 11 such that the height position of the surface of the hydrogen carrier is maintained within a predetermined range from γ to β. That is, the controller 112 opens the shutter 11d in accordance with a signal from the hydrogen carrier amount detection portion 15 to drop the hydrogen carrier down in the gravity direction, and thus supplies the hydrogen carrier to the storage portion 121 of the powder application apparatus 12.

Specifically, in the case of detecting that the height of the surface of the hydrogen carrier has decreased to a position equal to or lower than the position of γ serving as a first height in response to the height information of the surface of the hydrogen carrier received from the hydrogen carrier amount detection portion 15, the controller 112 determines that the amount of the hydrogen carrier in the storage portion 121 has decreased to be less than a predetermined amount. Then, as illustrated in FIG. 4, the controller 112 opens the shutter 11d, and replenishes the storage portion 121 with the hydrogen carrier from the hydrogen carrier storage case 11.

In contrast, in the case of detecting that the height of the surface of the hydrogen carrier has increased to a position equal to or higher than the position of β serving as a second height in response to the height information of the surface of the hydrogen carrier received from the hydrogen carrier amount detection portion 15, the controller 112 determines that the amount of the hydrogen carrier in the storage portion 121 has increased to be more than the predetermined amount. Then, as illustrated in FIG. 3, the controller 112 closes the shutter 11d to stop the supply of the hydrogen carrier from the hydrogen carrier storage case 11.

According to the present embodiment configured in this manner, the amount of the hydrogen carrier in the powder application apparatus 12 can be maintained within a predetermined range by controlling the replenishment amount of the hydrogen carrier supplied from the hydrogen carrier storage case 11 on the basis of the surface height of the hydrogen carrier in the storage portion 121 detected by the hydrogen carrier amount detection portion 15. As a result of this, sudden change in the amount of the hydrogen carrier in the powder application apparatus 12 can be suppressed, and change in the gravity force and the pressure on the hydrogen carrier near the opening portion 122 from the powder application apparatus 12 to the conveyance belt 41 can be also suppressed.

As a result of this, the uniformity of application of the hydrogen carrier from the powder application apparatus 12 onto the conveyance belt 41 can be stabilized. If the thickness of the hydrogen carrier applied on the conveyance belt 41 can be uniformized, occurrence of unevenness in the progress of the reaction caused by the supply of the liquid to the hydrogen carrier can be suppressed. Therefore, according to the configuration of the present embodiment, the reaction between the hydrogen carrier and the water-containing liquid on the conveyance belt 41 can be easily promoted.

To be noted, although a configuration in which the hydrogen carrier is supplied from the powder application apparatus 12 onto the conveyance belt 41 by gravity has been described in the above description, a configuration in which, for example, a rotary member such as a brush roller is disposed at the opening portion 122 and the supply of the hydrogen carrier onto the conveyance belt 41 is assisted by driving the rotary member may be employed. Also in the case of this configuration, the torque change caused by the difference between the case where the amount of the hydrogen carrier in the storage portion 121 is large and the case where the amount is small can be suppressed, and thus the uniformity of the application of the hydrogen carrier from the powder application apparatus 12 onto the conveyance belt 41 can be stabilized.

In addition, although a configuration in which the light emitting portion 15a and the light receiving portion 15c are arranged at different height positions has been described above, the light emitting portion 15a and the light receiving portion 15c may be respectively disposed at the position of β and the position of γ and the height of the surface of the hydrogen carrier reaching the position of β and the position of γ may be detected.

In addition, instead of the optical sensor described above, a piezoelectric sensor, an electrostatic capacitance sensor, an ultrasonic wave sensor, or the like may be used as the hydrogen carrier amount detection portion 15. In addition, a configuration in which the amount of the hydrogen carrier in the storage portion 121 is measured by detecting the weight of the powder application apparatus 12 may be employed.

In addition, although a configuration in which the replenishment of the powder application apparatus 12 with the hydrogen carrier from the hydrogen carrier storage case 11 is performed by gravity by opening the shutter 11d has been described above, a configuration in which the replenishment is performed by using a roller or a screw may be employed, and a configuration in which the replenishment is performed by using a belt or air may be employed. In the case of the configuration in which the hydrogen carrier is replenished by driving a different member as described above, it is preferable that the hydrogen carrier storage case 11 is disposed above the storage portion 121 of the powder application apparatus 12 to efficiently perform the replenishment of the hydrogen carrier although the hydrogen carrier storage case 11 does not need to be positioned above the powder application apparatus 12.

### Second Embodiment

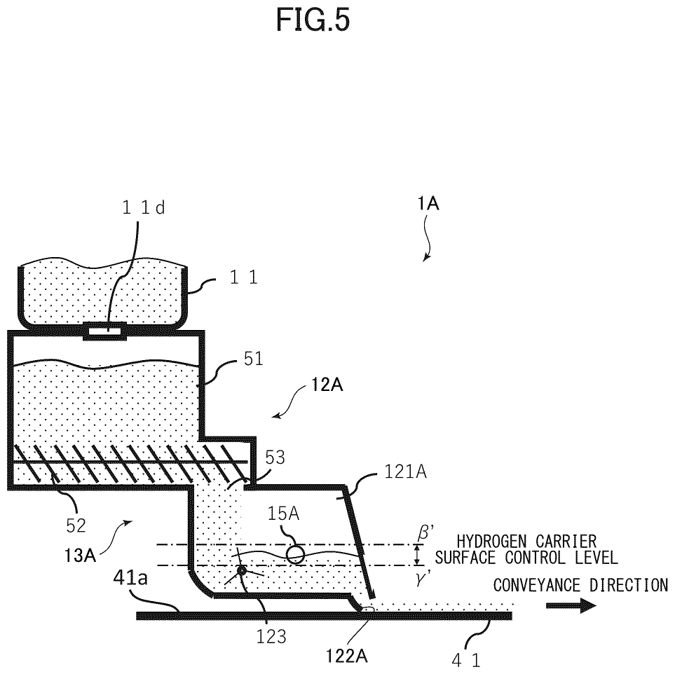

A second embodiment will be described by using FIG. 5. A hydrogen generation apparatus 1A of the present embodiment is different from the first embodiment in the configuration of the powder application apparatus and the hydrogen carrier regulated amount maintaining portion. The other elements and functions are similar to those of the first embodiment described above, and therefore similar elements are denoted by the same reference signs, description and illustration thereof are omitted or simplified, and part different from the first embodiment will be mainly described.

In the case of the present embodiment, a powder application apparatus 12A includes a hydrogen carrier hopper 51 serving as an accumulating portion that temporarily accumulates the hydrogen carrier supplied from the hydrogen carrier storage case 11, a storage portion 121A configured to store the hydrogen carrier, and a conveyance screw 52 serving as a supply portion that supplies the hydrogen carrier from the hydrogen carrier hopper 51 to the storage portion 121A. Similarly to the first embodiment, in the powder application apparatus 12A, an opening portion 122A is formed at a lower end portion of the storage portion 121A, and the hydrogen carrier in the storage portion can be supplied onto the surface 41a of the conveyance belt 41 by gravity through the opening portion 122A. To be noted, in the case of the present embodiment, the opening portion 122A is opened at a lower end portion closer to an end portion of the storage portion 121A in the horizontal direction. Therefore, a paddle 123 is provided in the storage portion 121A to agitate the hydrogen carrier in the storage portion 121A and convey the hydrogen carrier to the opening portion 122A.

A hydrogen carrier regulated amount maintaining portion 13A of the present embodiment adjusts the supply amount of the hydrogen carrier from the hydrogen carrier hopper 51 to the storage portion 121A to maintain the hydrogen carrier in the storage portion 121A within a predetermined range. The hydrogen carrier hopper 51 has a hopper function in which the hydrogen carrier hopper 51 receives supply of the hydrogen carrier from the hydrogen carrier storage case 11, temporarily accumulates the hydrogen carrier, and replenishes the storage portion 121A of the powder application apparatus 12A with the hydrogen carrier. The conveyance screw 52 is disposed in the hydrogen carrier hopper 51, loosens the hydrogen carrier in the hydrogen carrier hopper 51, and conveys and supplies the hydrogen carrier from the hydrogen carrier hopper 51 to the storage portion 121A.

The hydrogen carrier hopper 51 is disposed at a position below the hydrogen carrier storage case 11 and above the storage portion 121A, and the hydrogen carrier hopper 51 is replenished with the hydrogen carrier from the hydrogen carrier storage case 11 as a result of the shutter 11d of the hydrogen carrier storage case 11 opening. In addition, the conveyance screw 52 is disposed in an approximate horizontal direction at a lower portion of the hydrogen carrier hopper 51. Further, a communicating portion 53 where the hydrogen carrier hopper 51 and the storage portion 121A communicate with each other is formed at a downstream end portion in the hydrogen carrier conveyance direction of the conveyance screw 52, and the conveyance screw 52 rotates to replenish the storage portion 121A with the hydrogen carrier from the hydrogen carrier hopper 51 through the communicating portion 53. In the case of the present embodiment, the communicating portion 53 is formed at a lower end portion of the hydrogen carrier hopper 51 to open to the lower side, and the hydrogen carrier conveyed by the conveyance screw 52 is supplied to the storage portion 121A by gravity through the communicating portion 53.

The hydrogen carrier regulated amount maintaining portion 13A of the present embodiment includes a hydrogen carrier amount detection portion 15A capable of detecting information about the amount of the hydrogen carrier in the storage portion 121A of the powder application apparatus 12A, and the controller 112 (see FIG. 2) that controls the conveyance screw 52 on the basis of a signal of the hydrogen carrier amount detection portion 15A. The powder application apparatus 12A is disposed above the conveyance belt 41 as described above, and is capable of supplying the hydrogen carrier onto the conveyance belt 41 by gravity. Therefore, the hydrogen carrier amount detection portion 15A of the present embodiment is configured to detect information about the height of the upper surface (surface) of the hydrogen carrier in the storage portion 121A.

Specifically, the hydrogen carrier amount detection portion 15A is a piezoelectric sensor. In the case where “absence of hydrogen carrier” is detected by the piezoelectric sensor, the controller 112 drives the conveyance screw 52 for a predetermined time to replenish the storage portion 121A with the hydrogen carrier from the hydrogen carrier hopper 51. In contrast, in the case where “presence of hydrogen carrier” is detected by the piezoelectric sensor, the controller 112 stops the driving of the conveyance screw 52 to stop the replenishment of the hydrogen carrier from the hydrogen carrier hopper 51. By driving and stopping the conveyance screw 52 on the basis of the signal of the piezoelectric sensor like this, the height of the surface of the hydrogen carrier in the storage portion 121A can be maintained within a range from a position of γ′ to a position of β′, and the amount of the hydrogen carrier in the storage portion 121A can be maintained within a predetermined range.

To be noted, the hydrogen carrier hopper 51 may be additionally provided with a sensor (not illustrated) capable of detecting information about the amount of the hydrogen carrier therein such as the height position of the surface of the hydrogen carrier. In this case, the controller 112 controls the opening and closing of the shutter 11d of the hydrogen carrier storage case 11 on the basis of the signal of this sensor, and thus performs the replenishment from the hydrogen carrier storage case 11 to the hydrogen carrier hopper 51 and stop thereof. In addition, control may be performed such that the shutter 11d is opened while the conveyance screw 52 is driving and the shutter 11d is closed when the driving is stopped without providing a sensor like this.

In the case of the present embodiment configured in this manner, the amount of the hydrogen carrier in the storage portion 121A of the powder application apparatus 12A can be kept at a necessary minimum by providing the hydrogen carrier hopper 51. Therefore, the hydrogen carrier in the storage portion 121A does not receive a large gravity force or high pressure, thus clogging near the opening portion 122A of the storage portion 121A is less likely to occur, and the uniformity of the application of the hydrogen carrier on the conveyance belt 41 can be stabilized.

In addition, as a result of temporarily accumulating the hydrogen carrier in the hydrogen carrier hopper 51, the application of the hydrogen on the conveyance belt 41 can be continued by using the hydrogen carrier in the hydrogen carrier hopper 51 even while the hydrogen carrier storage case 11 is being replaced. Therefore, the operation of the hydrogen generation apparatus 1A can be continued even during replacement of the hydrogen carrier storage case 11, and thus the productivity can be improved.

To be noted, although a configuration in which the hydrogen carrier is supplied onto the conveyance belt 41 from the powder application apparatus 12A by gravity has been described above, similarly to the first embodiment, a configuration in which, for example, a rotary member such as a brush roller is disposed at the opening portion 122A and the supply of the hydrogen carrier onto the conveyance belt 41 is assisted by driving the rotary member may be employed.

In addition, instead of the piezoelectric sensor described above, an optical sensor, an electrostatic capacitance sensor, an ultrasonic wave sensor, or the like may be used as the hydrogen carrier amount detection portion 15A. In addition, a configuration in which the amount of the hydrogen carrier in the storage portion 121A is measured by detecting the weight of the storage portion 121A may be employed.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A hydrogen generation apparatus comprising:
a conveyance member capable of conveying a solid hydrogen carrier;
a replenishment container storing the hydrogen carrier for replenishment;
an application apparatus that includes a storage portion configured to store the hydrogen carrier supplied from the replenishment container and that is configured to apply the hydrogen carrier on the conveyance member from the storage portion;
an ejection apparatus configured to eject a solution containing water onto the hydrogen carrier applied on the conveyance member;
a hydrogen collection apparatus configured to collect hydrogen generated by a reaction between the hydrogen carrier and the solution on the conveyance member;
a byproduct collection apparatus configured to collect a byproduct generated by the reaction between the hydrogen carrier and the solution on the conveyance member; and
a hydrogen carrier regulated amount maintaining portion configured to adjust a replenishment amount of the hydrogen carrier from the replenishment container to the storage portion to maintain the hydrogen carrier in the storage portion within a predetermined range.

2. The hydrogen generation apparatus according to claim 1, further comprising:
a replenishment portion for replenishing the storage portion with the hydrogen carrier from the replenishment container,
wherein the hydrogen carrier regulated amount maintaining portion includes a hydrogen carrier amount detection portion capable of detecting information about an amount of the hydrogen carrier in the storage portion, and a controller configured to control the replenishment portion on a basis of a signal of the hydrogen carrier amount detection portion.

3. The hydrogen generation apparatus according to claim 2,
wherein the replenishment container is disposed above the storage portion and has an opening portion through which it is possible to supply the hydrogen carrier into the storage portion by gravity, and
wherein the replenishment portion is a shutter capable of opening and closing the opening portion.

4. The hydrogen generation apparatus according to claim 2,
wherein the application apparatus is disposed above the conveyance member and capable of supplying the hydrogen carrier to the conveyance member by gravity, and
wherein the hydrogen carrier amount detection portion detects information about a height of an upper surface of the hydrogen carrier in the storage portion.

5. A hydrogen generation apparatus comprising:
a conveyance member capable of conveying a solid hydrogen carrier;
a replenishment container storing the hydrogen carrier for replenishment;
an application apparatus including an accumulating portion configured to temporarily accumulate the hydrogen carrier supplied from the replenishment container, a storage portion configured to store the hydrogen carrier, a supply portion configured to supply the hydrogen carrier from the accumulating portion to the storage portion, and configured to apply the hydrogen carrier on the conveyance member from the storage portion;
an ejection apparatus configured to eject a solution containing water onto the hydrogen carrier applied on the conveyance member;
a hydrogen collection apparatus configured to collect hydrogen generated by a reaction between the hydrogen carrier and the solution on the conveyance member;
a byproduct collection apparatus configured to collect a byproduct generated by the reaction between the hydrogen carrier and the solution on the conveyance member; and
a hydrogen carrier regulated amount maintaining portion configured to adjust a supply amount of the hydrogen carrier from the accumulating portion to the storage portion to maintain the hydrogen carrier in the storage portion within a predetermined range.

6. The hydrogen generation apparatus according to claim 5, wherein the hydrogen carrier regulated amount maintaining portion includes a hydrogen carrier amount detection portion capable of detecting information about an amount of the hydrogen carrier in the storage portion, and a controller configured to control the supply portion on a basis of a signal of the hydrogen carrier amount detection portion.

7. The hydrogen generation apparatus according to claim 5, wherein the supply portion is a conveyance screw configured to convey the hydrogen carrier from the accumulating portion to the storage portion.

8. The hydrogen generation apparatus according to claim 6,
wherein the application apparatus is disposed above the conveyance member and capable of supplying the hydrogen carrier to the conveyance member by gravity, and
wherein the hydrogen carrier amount detection portion detects information about a height of an upper surface of the hydrogen carrier in the storage portion.

9. The hydrogen generation apparatus according to claim 1, wherein the replenishment container is replaceable.

10. The hydrogen generation apparatus according to claim 1, wherein the conveyance member is a conveyance belt.

11. The hydrogen generation apparatus according to claim 5, wherein the replenishment container is replaceable.

12. The hydrogen generation apparatus according to claim 5, wherein the conveyance member is a conveyance belt.
